(19) United States
(12) Patent Application Publication
(10) Pub. No.: US 2022/0284592 A1
(43) Pub. Date: Sep. 8, 2022

(54) System and method for predicting trajectory of non-stationary obstacles in an aerial movement volume

(71) Applicant: Everseen Limited, Blackpool (IE)

(72) Inventors: Dan Alexandru Pescaru, Timisoara (RO); Vasile Gui, Timisoara (RO); Cosmin Cernazanu-Glavan, Timisoara (RO); Ciprian David, Satu Mare (RO)

(73) Assignee: Everseen Limited, Blackpool (IE)

(21) Appl. No.: 17/192,378

(22) Filed: Mar. 4, 2021

(51) Int. Cl. G06T 7/20; G06T 7/70; B64C 39/02; G05D 1/10

(52) U.S. Cl. CPC G06T 7/20; G06T 7/70; B64C 39/024; G05D 1/106; G06T 2207/30241; G06T 2207/10024; G06T 2207/10044; B64C 2201/141; G01S 13/933

(57) ABSTRACT

A system for navigating an aerial robotic device (ARD) includes an object detection module for detecting a non-stationary object in aerial movement volume, an object tracking module for adding location of the non-stationary object from a first object record to a first position of a tracking list of a substantially matching second object record a trajectory prediction module for updating a prediction list of the substantially matching second object record with one or more next trajectory points predicted over a predefined time period T, including determining an acceleration vector of the object in a next sample based on magnitude of current longitudinal and normal components of acceleration vector, and a phase of the velocity vector in next sample; and predicting a trajectory point of corresponding object in next sample accordingly, and a collision avoidance module for navigating the ARD in presence of a non-stationary object based on the updated prediction list.

### TECHNICAL FIELD

The present disclosure relates generally to a navigation control for an aerial robotic device, and more particularly to a mechanism for navigating an aerial robotic device in the presence of static and non-stationary obstacles within a bounded movement volume.

### BACKGROUND

An unmanned aerial vehicle (UAV) (or uncrewed aerial vehicle, commonly known as a drone) is an aircraft without a human pilot on board and a type of unmanned vehicle. UAVs are a component of an unmanned aircraft system (UAS), which include the UAV, a ground-based controller, and a system of communications between the two. The flight of UAVs may operate with various degrees of autonomy, either under remote control by a human operator or autonomously by onboard computers.

Traditional wired aerial robotic devices require manual control of their movements by a trained operator using a joystick apparatus. However, this is an overly labour-intensive process, and requires significant motor skills on the part of the human operator. Also, the navigation of the aerial robotic device becomes difficult in the presence of stationary and non-stationary obstacles. It is crucial to automatically enable the aerial robotic device to avoid moving obstacles (e.g. incoming vehicles into a drive through facility or pallet loading area etc.) in its path as it moves from a first location to a second location in the space covered by the aerial movement volume.

### SUMMARY

In an aspect of the present disclosure, there is provided a system for navigating an aerial robotic device (ARD) from a first location to a second location in an aerial movement volume. The system includes an object detection module configured to detect one or more non-stationary objects in the aerial movement volume, and generate a first object record detailing the location of the non-stationary object. The system further includes an object tracking module configured compare the first object record with one or more second object records of objects previously detected in the aerial movement volume, and add the location of the non-stationary object from the first object record to a first position of a tracking list of a substantially matching second object record, such that the tracking list includes a sequentially ordered list of a current and previous trajectory points comprising the current location of the non-stationary object and the locations of one or more previous detections of the corresponding non-stationary object. The system furthermore includes a trajectory prediction module configured to update a prediction list of the substantially matching second object record with one or more next trajectory points predicted over a predefined time period T, wherein N samples of a first object record are acquired at the pre-defined rate At over the pre-defined time period T and wherein, for each current sample, the updating of the prediction list comprises: filtering out measurement noise in the current and previous trajectory points of the tracking list to generate a filtered tracking list of one or more filtered trajectory points; determining a velocity vector of the corresponding object in the current sample based on the filtered trajectory points; determining an acceleration vector of the corresponding object in the current sample based on the velocity vector of the corresponding object in the current and previous samples; determining the longitudinal and normal components of the acceleration vector in the current sample relative to the velocity vector in the current sample; determining an acceleration vector of the corresponding object in a next sample based on the magnitude of the current longitudinal and normal components of the acceleration vector, and a phase of the velocity vector in the next sample; and predicting a trajectory point of the corresponding object in the next sample, based on the velocity and acceleration vectors predicted in the next sample. The system further includes a collision avoidance module configured to navigate the ARD from the first location to the second location in the presence of a non-stationary object based on the updated prediction list of the non-stationary object.

In another aspect of the present disclosure, there is provided a method for navigating an aerial robotic device (ARD) from a first location to a second location in an aerial movement volume. The method includes detecting, by an object detection module, one or more non-stationary objects in the aerial movement volume. The method further includes generating, by the object detection module, a first object record detailing the location of the non-stationary object. The method further includes comparing, by an object tracking module, the first object record with one or more second object records of objects previously detected in the aerial movement volume and adding the location of the non-stationary object from the first object record to a first position of a tracking list of a substantially matching second object record, such that the tracking list includes a sequentially ordered list of a current and previous trajectory points comprising the current location of the corresponding non-stationary object and the location of one or more previous detections of the corresponding non-stationary object

The method further includes updating, by a trajectory prediction module, a prediction list of the substantially matching second object record with one or more next trajectory points predicted over a predefined time period T, wherein N samples of a first object record are acquired at the pre-defined rate At over the pre-defined time period. The updating of the prediction list for each current sample comprises filtering out measurement noise in the current and previous trajectory points of the tracking list to generate a filtered tracking list of one or more filtered trajectory points; determining a velocity vector of the corresponding object in the current sample based on the filtered trajectory points; determining an acceleration vector of the corresponding object in the current sample based on the velocity vector of the corresponding object in the current and previous samples; determining the longitudinal and normal components of the acceleration vector in the current sample relative to the velocity vector in the current sample; determining an acceleration vector of the corresponding object in a next sample based on the magnitude of the current longitudinal and normal components of the acceleration vector, and a phase of the velocity vector in the next sample; and predicting a trajectory point of the corresponding object in the next sample, based on the velocity and acceleration vectors predicted in the next sample. The method further includes navigating the ARD from the first location to the second location in the presence of a non-stationary object based on the updated prediction list of the non-stationary object.

In yet another embodiment of the present disclosure, there is provided a non-transitory computer readable medium configured to store a program causing a computer to navigate an aerial robotic device (ARD) from a first location to a second location in an aerial movement volume. The said program is configured to detect a non-stationary object in the aerial movement volume, and generate a first object record detailing the location of the non-stationary object; compare the first object record with one or more second object records of objects previously detected in the aerial movement volume, and add the location of the non-stationary object from the first object record to a first position of a tracking list of a substantially matching second object record, such that the tracking list includes a sequentially ordered list of a current and previous trajectory points comprising the current location of the corresponding non-stationary object and the locations of one or more previous detections of the corresponding non-stationary object; update a prediction list of the substantially matching second object record with one or more next trajectory points predicted over a predefined time period T, wherein N samples of a first object record are acquired at the pre-defined rate At over the pre-defined time period T and wherein, for each current sample, the updating of the prediction list comprises: filtering out measurement noise in the current and previous trajectory points of the tracking list to generate a filtered tracking list of one or more filtered trajectory points; determining a velocity vector of the corresponding object in the current sample based on filtered trajectory points of the corresponding object in the current and previous samples; determining an acceleration vector of the corresponding object in the current sample based on the velocity vector of the corresponding object in the current and previous samples; determining the longitudinal and normal components of the acceleration vector in the current sample relative to the velocity vector in the current sample; determining an acceleration vector of the corresponding object in a next sample based on the magnitude of the current longitudinal and normal components of the acceleration vector, and a phase of the velocity vector in the next sample; and predicting a trajectory point of the corresponding object in the next sample, based on the velocity and acceleration vectors predicted in the next sample. The said program is further configured to navigate the ARD from the first location to the second location in the presence of a non-stationary object based on the updated prediction list of the non-stationary object.

Various embodiments of the present disclosure provide a system for navigating an aerial robotic device in the presence of non-stationary obstacles within an aerial movement volume of the aerial robotic device. The aerial robotic device is enabled to avoid moving obstacles, for example, incoming vehicles into a drive through facility or pallet loading area etc. in its path as it moves from a first location to a second location in the space covered by the aerial movement volume, using various tracking techniques, prediction algorithms and real time route management.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates an aerial module that includes a plurality of upright members, in accordance with an embodiment of the present disclosure;

FIG. 2 illustrates an optimal navigation path of the aerial robotic device (ARD) to avoid collision with stationary obstacles in an inclined plane;

FIG. 3A illustrates graphical representation of a scenario in which first and second non-stationary objects are detected proximal to the ARD, in accordance with an embodiment of the present disclosure;

FIG. 3B is a block diagram of a prediction based navigation control system for the ARD, in accordance with an embodiment of the present disclosure;

FIG. 4 is a flowchart illustrating a method for detecting non-stationary obstacles in the aerial movement volume, in accordance with an embodiment of the present disclosure;

FIG. 5 is a flowchart illustrating a method for tracking non-stationary obstacles detected in the aerial movement volume, in accordance with an embodiment of the present disclosure;

FIG. 6 is a flowchart illustrating a method for predicting trajectory points of non-stationary obstacles tracked in the aerial movement volume, in accordance with an embodiment of the present disclosure;

FIG. 7 illustrates a schema on which a collision forecasting algorithm is based, in accordance with an embodiment of the present disclosure;

FIGS. 8A and 8B are a flowchart illustrating a method for preventing collision between the ARD and the obstacles, in accordance with an embodiment of the present disclosure;

FIGS. 9A and 9B illustrate an ARD overtaking an obstacle in the left direction to avoid a collision;

FIGS. 10A and 10B illustrate an ARD overtaking an obstacle in the right direction to avoid a collision; and

FIGS. 11A and 11B illustrate an ARD overtaking an obstacle in an overhead direction to avoid a collision.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

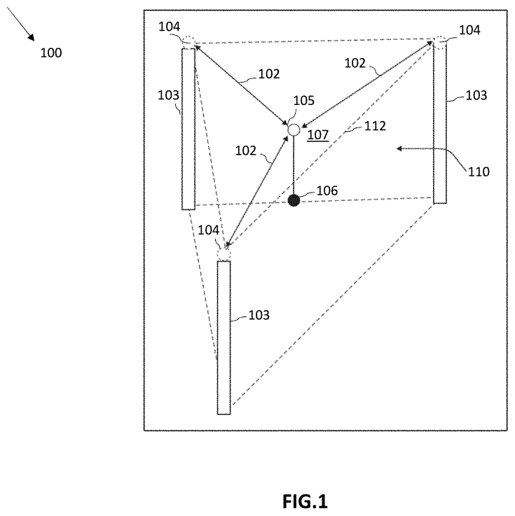

FIG. 1 illustrates an aerial module 100 that includes a plurality of upright members 103, each of which is at least partly driven into the ground, in a substantially perpendicular orientation relative to the ground. An example of the upright member 103 includes, but is not limited to, a pillar or pole. An elevated anchor point 104 is mounted on each upright member 103 at a substantially same height (h) as from the ground. Each elevated anchor point 104 comprises an electric stepper motor (not shown) which in turn includes a rotor (not shown). Each rotor is coupled with a first end of a wire 102 which is arranged so that the rest of the wire 102 is at least partly wrapped around the rotor. The other end of each wire 102 is coupled with a carrier device 105. The carrier device 105 itself houses at least one electric motor (not shown), each of which includes a rotor (not shown). The rotor of the carrier device 105 is coupled with a first end of a wire 107, and an aerial robotic device (ARD) 106 suspended from the other end of the wire 107. Thus, the wires 102, anchor points 104, upright members 103 and the ground effectively define an aerial movement volume 110 within which the ARD 106 resides.

The carrier device 105 is adapted to move within a bounded horizontal plane 112 defined by the elevated anchor points 104. This movement is achieved through the activation of the electric motors in the anchor points 104 to cause the wire 102 coupled to each electric motor to be further wound or unwound from the electric motor's rotor, thereby shortening or lengthening each such wire 102. The ARD 106 is adapted to move vertically relative to the carrier device 105 through the activation of the electric motor(s) in the carrier device 105 to cause the wire coupled to each electric motor to be further wound or unwound from the electric motor's rotor, thereby shortening or lengthening the wire.

In the context of the present disclosure, one or more stationary and/or moving objects may also be present in the aerial movement volume 110. Thus, the problem solved by the present disclosure is that of enabling the ARD 106 to navigate from a first location to a second location in the aerial movement volume 110, while avoiding moving and stationary objects along the way. The non-stationary objects are hereinafter alternatively referred to as non-stationary obstacles or moving objects or moving obstacles, throughout the document.

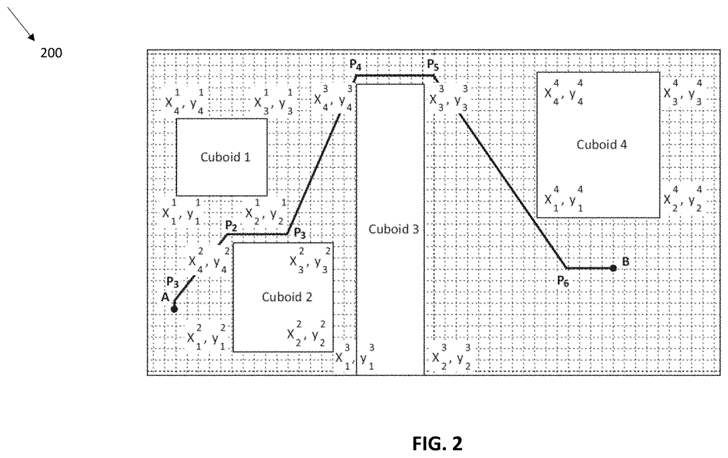

FIG. 2 illustrates an optimal navigation path 200 of the ARD to avoid collision with stationary objects in an inclined plane. The navigation of the ARD to avoid stationary objects is optimized on an inclined plane between a current position ‘A’ and a target position ‘B’. In the context of the present disclosure, the ARD follows the optimal navigation path 200 from ‘A’ to when the non-stationary obstacles are not detected. Various stationary obstacles are hereinafter represented by cuboid 1, cuboid 2, cuboid 3 and cuboid 4. The optimal navigation path 200 of the ARD is determined so as to not to collide with such stationary obstacles.

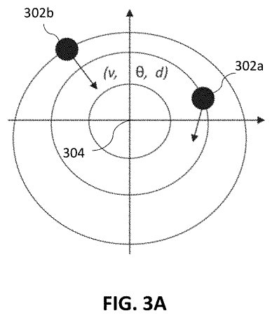

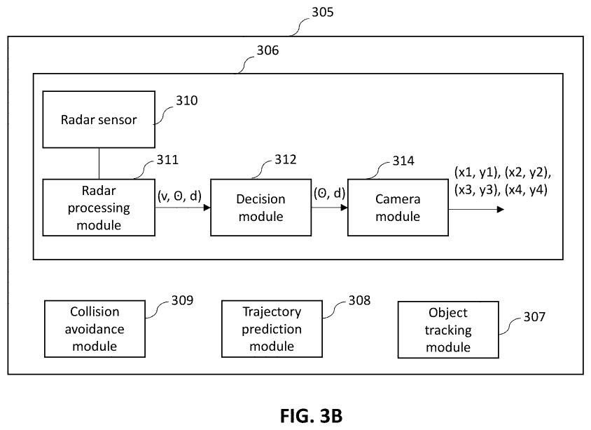

FIG. 3A illustrates a graphical representation of a scenario in which first and second non-stationary objects 302a and 302b are detected within a predefined region of an aerial robotic device (ARD) 304 (similar to the ARD 106 of FIG. 1), in accordance with an embodiment of the present disclosure. Each of the first and second non-stationary objects 302a and 302b has a speed (v), a direction of movement (θ), and a distance (d) from the ARD 304.

FIG. 3B is a block diagram of a prediction based navigation control system 305 for the ARD 304, in accordance with an embodiment of the present disclosure.

The prediction based navigation control system 305 includes an object detection module 306, an object tracking module 307, a trajectory prediction module 308, and a collision avoidance module 309. The object detection module 306 is configured to detect one or more non-stationary objects within the pre-defined region of the ARD 304.

The non-stationary objects include earth-bound objects such as vehicles, buildings and people, and not flying objects. The object detection module 306 includes a radar sensor 310 for mounting on the ARD 304, and configured to detect non-stationary objects within a pre-defined distance of the ARD 304. The object detection module 306 further includes a radar processing module 311 configured to process data from the radar sensor 310 to determine a speed v and a direction of movement 9 of non-stationary objects within a pre-defined distance of the ARD 304. In the context of the present disclosure, the distance is pre-defined based on a detection range of the radar sensor 310. It is to be noted that since the radar sensor 310 is for mounting on the ARD 304 the radar sensor 310 is moved about the the aerial movement volume 110 shown in FIG. 1, by the corresponding movements of the ARD 304. However, the radar sensor 310 maintains a constant orientation relative to the direction of movement of the ARD 304.

The object detection module 306 further includes a decision module 312 configured to determine whether each of the detected first and second objects 302a and 302b is stationary or non-stationary. The decision module 312 is further configured to determine whether the ARD 304 is likely to collide with the second object 302b, or whether the ARD 304 is likely to merely pass by the first object 302a without colliding with it. For brevity, an object with which the ARD 304 is likely to collide may be hereinafter referred to as an obstacle.

In the context of the present disclosure, a 12 o'clock position relative to the ARD 304 is defined to be a 0 degrees angular deviation from the ARD 304, and angles progressing in a clockwise direction from the 12 o'clock position are defined to be positively valued angular deviations in the range 0 to 360 degrees. By the same token, an object moving along a path oriented towards the 12 o'clock position relative to the object, is defined to be moving in a 0 degrees direction, and an object moving in the opposite direction (i.e. towards the 6 o'clock position relative to the object) is defined to be moving in a 180 degrees direction. Thus, an object moving along a path oriented at angles progressing in a clockwise direction from the 12 o'clock position relative to the object is defined to be moving in a direction of 0 to 360 degrees.

In an example, when an object has zero speed and is disposed at 0 degrees angular deviation from the ARD 304, the object is straight ahead of the ARD 304, and the ARD 304 may collide with the object if the ARD 304 continues on its current trajectory. In another example, if an object is determined to be disposed at 0 degrees angular deviation from the ARD 304 and is moving in a 180 degrees direction, i.e. towards the ARD 304, the object is an incoming object, and the ARD 304 may collide with the incoming object if the ARD 304 continues on its current trajectory. In another example, if an object is determined to be disposed at 0 degrees angular deviation from the ARD 304 and is moving in a 0 degrees direction, i.e. away from the ARD 304, the object is an outgoing object, and if the outgoing object is moving faster than the ARD 304, the ARD 304 is unlikely to collide with the outgoing object.

It will be understood that the above-mentioned angular deviations of an object from the ARD 304 and the above-mentioned directions of movement of the object are provided for the purpose of example. In particular, the definition of an “incoming” or “outgoing” status of an object is in no way limited to these angular deviations and directions of movement of the object. Instead, an incoming object will be understood to be an object whose direction of movement from its current position, described with reference to the orientation of the radar sensor 310, causes the object to move towards the ARD 304. Similarly, an outgoing object is an object whose direction of movement from its current position, described with reference to the orientation of the radar sensor 310, causes the object to move away from the ARD 304.

In an embodiment of the present disclosure, the decision module 312 is configured to detect a moving object in the vicinity of the ARD 304 and also determines whether the moving object is an incoming object, or an outgoing object based on the direction of movement of the corresponding object described with reference to the orientation of the radar sensor 310. The decision module 312 is further configured to transmit an alert message to a camera module 314 upon detection by the decision module 312 of an incoming object. In an example, the camera module 314 includes an Red Green Blue Depth (RGBD) camera and a signal processing unit coupled with the carrier device 105 of FIG. 1. The alert message triggers the camera module 314 to capture an image or a video frame of the surrounding area of the ARD 304, and to compute coordinates of one or more 3D bounding boxes enclosing one or more objects in the vicinity of the ARD 304 with respect to the captured image or video frame. Thus, the camera module 314 outputs a list of the parameters of the bounding boxes that enclose the objects detected at a given moment t. For each bounding box, the parameters include a list of four points (comprising the x and y coordinates of the four vertices (x₁, y₁), (x₂, y₂), (x₃, y₃) and (x₄, y₄) of a horizontal rectangular face of the bounding box) and an elevation value el (representing the height of the bounding box).

For brevity, the data generated by the camera module 314 is hereinafter referred to as a sample. Similarly, a sampling rate corresponds to a time interval Δt between the generation of consecutive samples, and a sample time is the time (tᵢ) at which an i^{th} sample is generated. The sampling rate may depend on the acquisition rate of the radar sensor 308. In an example, the sampling rate is 40 ms. In another example, the sampling rate is 10 ms. Nevertheless, it should be noted that the time interval between consecutive samples may not be uniform. In particular, at any given moment, there may not be any incoming moving objects in the vicinity of the ARD 304 to cause the RGBD camera to be triggered to capture an image/video frame. Thus, the time interval between consecutive samples is dependent on the presence of incoming objects in the vicinity of the ARD 304, rather than the acquisition rate of the sensors. The sampling is performed until the ARD 304 reaches its target position.

For clarity, the coordinates (x₁, y₁), (x₂, y₂), (x₃, y₃) and (x₄, y₄) are all defined in absolute terms with reference to the aerial movement volume 110, rather than with reference to the ARD 304. Specifically, the absolute coordinates of a moving object at any given moment are established within a reference system defined by the upright members 103, anchor points 104 and the ground that collectively establish the boundaries of the aerial movement volume 110.

The object detection module 306 is further configured at any given sample time t_{τ} to establish NR (t_{τ}) current object records

$${( {CObj}_{p}^{{t}_{τ}} )}_{p = 1 to NR ( {t}_{τ} )}$$

each of which includes details of a corresponding one of NR(t_{τ}) objects detected in the vicinity of the ARD 304 at the sample time t_{τ}. The said details are derived from a sample generated at the sample time t_{τ}. The NR (t_{τ}) current object records

$${( {CObj}_{p}^{{t}_{τ}} )}_{p = 1 to NR ( {t}_{τ} )}$$

may be used to populate or update an Object List ObjList(t_{τ-1}) comprising a plurality of stored object records of objects detected at the immediately preceding sample time t_{τ-1}. Specifically, when a new sample is generated, the existing details in the Object List ObjList(t_{τ-1}) are updated with the details of the objects detected in the new sample to create Object List ObjList(t_{τ}).

In an embodiment of the present disclosure, an individual current object record

$${( {CObj}_{p}^{{t}_{τ}} )}_{p = 1 to NR ( {t}_{τ} )}$$

may be described as

CObjₚ^{t}^{_{τ}}={{I, L, H}ₚ^{t}^{_{τ}},{x_{c}, y_{c}, z_{c}}ₚ^{t}^{_{τ}}}

where
{I, L, H}ₚ^{t}^{_{τ}}=a set of three values representing the physical dimensions of the bounding box enclosing a corresponding p^{th} detected object; wherein l and L are the lengths of the edges of the rectangle representing the horizontal projection of the bounding box, calculated from the x and y coordinates of the four vertices (x₁, y₁), (x₂, y₂), (x₃, y₃) and (x₄, y₄) of a horizontal rectangular face of the bounding box, and H is the elevation of the bounding box; and
{x_{c}, y_{c}, z_{c}}ₚ^{t}^{_{τ}}=three coordinates representing the 3D position of the center of gravity of the bounding box volume enclosing the p^{th} detected object.
   For brevity, the lengths of edges of a rectangle representing the horizontal projection of a bounding box and the elevation of the bounding box will be collectively referred to henceforth as the external parameters of the bounding box. Similarly, and for further brevity, the x, y and z coordinates representing the 3D position of a center of gravity of the bounding box volume will be referred to henceforth as the center of gravity coordinates of the bounding box.

In an embodiment of the present disclosure, an individual stored object record

$${( {Obj}_{p}^{{t}_{τ - 1}} )}_{p = 1 to NR ( {t}_{τ} )}$$

may be described as

Objₚ^{t}^{_{τ−1}}={Object IDₚ, {I, L, H}ₚ^{t}^{_{τ−1}},{x*_{c}, y*_{c}, z*_{c}}ₚ^{t}^{_{τ−1}}, TL[]ₚ^{t}^{_{τ−1}},PLHₚ^{t}^{_{τ−1}}}

where
Object IDₚ=an object identification number, which may be initially set to Null, and may be filled later;
{I, L, H}ₚ^{t}^{_{τ−1}}=the external parameters of the bounding box enclosing a corresponding p^{th} object detected at the most recent previous sample time t_{31 1}, which may initially be set to Null,
{x*_{c},y*_{c},z*_{c}}ₚ^{t}^{_{τ−1}}=the center of gravity coordinates of the bounding box enclosing the pth object, which may initially be set to Null;
TL[]ₚ^{t}^{_{τ}}=Tracking list, which may be initially empty, to be then populated with details of previous locations of the p^{th} object; and
PL[]ₚ^{t}^{_{τ}}=Prediction list, which may be initially empty, to be then populated with predicted future locations of the p^{th} object based on its estimated trajectory. The estimated trajectory will be explained later.

The object tracking module 307 is configured to receive the Object List ObjList(t_{τ-1}) from the object detection module 306 and employ an object tracking algorithm to track each non-stationary object detected within a predefined region of the ARD 304. In an embodiment of the present disclosure, the object tracking module 307 initializes the object tracking algorithm when a first sample is acquired, i.e. at sample time t₀. The initialization includes assigning a unique number to the object ID of each stored object record Objₚ^{t}^{₀} in the Object List ObjList(t₀). An object ID remains assigned to a stored object record, for as long as the corresponding object remains in the vicinity of the ARD 304, i.e. for as long as the stored object record appears in the Object List ObjList(t_{τ}). If the object leaves the vicinity of the ARD 304 and later returns, a new stored object record may be created in the Object List ObjList(t_{τ}) for the object, and a new object ID is assigned to the new stored object record.

In an embodiment of the present disclosure, the object tracking module 307 is configured to track an object by monitoring a center of gravity of its corresponding bounding box. For a cuboid, the center of gravity is defined by the three coordinates (x_{c}, y_{c}, z_{c}). As it has been mentioned before, detected objects are assumed to be earth-bound and not flying objects. Thus, the z coordinates of an object remain constant between successive samples (i.e. z_{c}^{t}^{ᵢ}=z_{c}^{t}^{ᵢ₊₁}) and the comparison of centers of gravity is performed on the basis of the x and y coordinates only.

More specifically, let a current sample time be t_{q} and let there be NR(t_{q}) objects detected in the vicinity of the ARD 304 at current sample time t_{q}. The details, extracted from the sample generated at sample time t_{q}, of each of the NR(t_{q}) objects are contained in each of the corresponding current object records

$${( {CObj}_{p}^{{t}_{q}} )}_{p = 1 to NR ( {t}_{q} )} .$$

Let the object list ObjList(t_{q-1}) from the most recent previous sample time t_{q-1} contain NR(t_{q-1}) stored object records. Using this formulation, the object tracking module 307 is configured to compare each current object record

$${( {CObj}_{p}^{{t}_{q}} )}_{p = 1 to NR ( {t}_{q} )}$$

with each of the NR(t_{q-1}) stored object records contained in the object list ObjList(t_{q-1}).

For brevity, an p^{th} stored object record in the object list ObjList(t_{q-1}) will be referred to henceforth as a first query object record. Similarly, a current object record (CObjₚ^{tq}) containing the details of a p^{th} object detected in the vicinity of the ARD 304 at the current sample time t_{q} will be referred to henceforth as a second query object record. Let (x*_{c}, y*_{c})^{r,t}^{_{q−1}} be the x and y center of gravity coordinates of the bounding box volume enclosing the object represented by the first query object record. Similarly, let

$${( {x}_{c} , {y}_{c} )}_{p = 1 to NR ( {t}_{q} )}^{p , {t}_{q}}$$

be the x and y center of gravity coordinates of the bounding box volume enclosing the object represented by the second query object record. The object tracking module 307 is configured to calculate a distance Δ between the first query object record and the second query object record as follows:

$$Δ = {‖ {( {x}_{c}^{*} , {y}_{c}^{*} )}^{r , {t}_{q - 1}} - {( {x}_{c} , {y}_{c} )}^{p , {t}_{q}} ‖}_{r = 1 to NR ( {t}_{q - 1} )}^{p = 1 to NR ( {t}_{q} )}$$

The object tracking module 307 is further configured to compare the value of the calculated distance A with a predefined threshold value Th. In the event the distance Δ is less than the threshold value Th, the object tracking module 307 is configured to establish that the first query object record matches the second query object record. In this case, at least some of the details of the first query object record are updated with corresponding details from the second query object record.

Specifically, in an embodiment of the present disclosure, the updating includes replacing the values of the external parameters of the bounding box of the first query object record with the corresponding values of the external parameters of the bounding box of the second query object record. The updating further includes replacing the values of the x, y and z center of gravity coordinates (x*_{c}, y*_{c},z*_{c}) of the first query object record with the values of the corresponding center of gravity coordinates (x_{c}, y_{c}, z_{c}) of the second query object record. The updating further includes adding the x and y center of gravity coordinates (x_{c}, y_{c}) of the second query object record to the Tracking List TL of the first query object record. Specifically, the x and y center of gravity coordinates (x_{c}, y_{c}) of the second query object record are added to the top of the Tracking List TL of the first query object record. In this way, the Tracking List TL of a stored object record includes a sequentially ordered list of the center of gravity variables of an object detected in the vicinity of the ARD 304 at previous sample times. If the Tracking List TL of a first query object record is already full, before commencement of the updating process, the center of gravity coordinates at the bottom of the Tracking List TL, i.e. from the earliest detection of the corresponding object, are deleted from the Tracking List TL; and the remaining center of gravity coordinates are shifted one step closer to the bottom of the Tracking List TL, to vacate the top of the Tracking List TL to receive the values of the center of gravity coordinates from the second query object record.

Alternatively, in the event the distance Δ exceeds the predefined threshold value Th, the object tracking module 307 is configured to determine that the first query object record does not match the second query object record. By progressing through the object list ObjList(t_{q-1}) and taking each stored object record therein to be a first query object record for comparison with the second query object record, it is possible to determine if the second query object record matches any of the stored object records in the object list ObjList(t_{q-1}). In the event a match is not found, it may be determined that the object whose details are contained in the second query object record is a newly detected object. In this case, the object tracking module 307 is configured to update the object list ObjList(t_{q-1}) by creating a new stored object record therein, allocating a new unique object ID to the new stored object record; and populating the new stored object record with the details from the second query object record.

The process of updating the object list ObjList(t_{q-1}), on the basis of the comparison of each stored object record contained therein with a current object record

$${( {CObj}_{p}^{{t}_{q}} )}_{p = 1 to NR ( {t}_{q} )} ,$$

is continued tor each object detected in the vicinity of the ARD 304 at the current sample time t_{q}. If, at the end of the updating process, the object list ObjList(t_{q-1}) contains stored object records that do not include values derived from the sample generated at the current sample time t_{q}, these stored object records are deleted from the object list ObjList(t_{q-1}) as they relate to objects that are no longer detected in the vicinity of the ARD 304. On completion of this step, the time index of the object list is incremented, so that ObjList(t_{q-1}) becomes ObjList(t_{q}). Accordingly, the current object list ObjList(t_{q}) now includes a stored object record for each object detected in the vicinity of the ARD 304 at current sample time t_{q}, such that

ObjList(t_{q})=[Obj₁^{tq}, Obj₂^{t}^{_{q}}, . . . , Obj_{NR(t}_{_{q}}₎^{t}^{_{q}}] (1)

Each such stored object record includes details of a corresponding object, the said details being determined from a sample generated at the current sample time t_{q}. Each such stored object record further includes the past locations, if any, of the center of gravity of the object determined from M previously generated samples, such that

Objᵢ^{t}^{_{q}}={objIDᵢ, {I, D, L}ᵢ{x_{c}, y_{c}}ᵢ^{t}^{_{q}}, [{x_{c}, y_{c}}ᵢ^{t}^{_{q−1}}, . . . , {x_{c}, y_{c}}ᵢ^{t}^{_{q−M}}], PL[]} (2)

where:
objIDᵢ=the object ID;
{I, L, H}ᵢ=the external parameters of the bounding box enclosing the i^{th} object detected at current sample time t_{q};
{x_{c}, y_{c}, z_{c}}ᵢ^{t}^{_{q}}=the center of gravity coordinates of the bounding box enclosing the i^{th} detected object;
Tracking List TL=[{x_{c}, y_{c}}ᵢ^{t}^{_{q}}, {x_{c}, y_{c}}^{t}^{_{q−1}}, . . . , {x_{c}, y_{c}}ᵢ^{t}^{_{q−M}}] is populated with details of the previous locations of the i^{th} detected object (represented by the x and y center of gravity coordinates of the of the i^{th} detected object determined from the M immediately preceding samples); and
Prediction list PL[]=an empty set to be populated with the predicted future locations of the i^{th} detected object.

The trajectory prediction module 308 is configured to predict future trajectories of all the tracked non-stationary objects over N time windows, each of duration Δt. The overall time interval=N×Δt may be hereinafter referred to as a future time window. In other words, assuming a set of observed non-stationary object trajectory points, (xᵢ, yᵢ), i=1,2, . . . , R, the goal is to predict a set of future trajectory points, (xₖ,yₖ), for k=R+1, R+2, . . . , R+N. By representing each of the non-stationary objects detected proximal to the ARD 304 as a 3D bounding box and predicting their future trajectories, it is possible to anticipate the risk of a collision between the ARD 304 and nearby non-stationary objects.

In an embodiment of the present disclosure, the trajectory prediction module 308 is configured to estimate future trajectory points for each object using a dynamic model of a non-stationary object and a set of observed trajectory points. The trajectory prediction module 308 receives the object list ObjList(t_{q}) (as defined in equation (1)) as an input from the object tracking module 307, and generates an updated Object List ObjList(t_{q}) as an output, in which each stored object record Objᵢ^{t}^{_{q}} has the form:

{objIDᵢ, {I, L, H}ᵢ, {x_{c}, y_{c}, z_{c}}ᵢ^{t}^{_{q}}, [{\tilde{x}_{c}, \tilde{y}_{c}}ᵢ^{t}^{_{q−1}}, . . . , {\tilde{x}_{c}, \tilde{y}_{c}}ᵢ^{t}^{_{q−M}}], [{x_{c}, y_{c}}ᵢ^{t}^{_{q}}⁺¹, . . . , {x_{c}, y_{c}}ᵢ^{t}^{_{q}}^{+N}]} (3)

Representing the center of gravity of an object by the center of gravity coordinates of a bounding box enclosing the object, the Tracking List TL of a given stored object record, in the updated Object List ObjList(t_{q}), is updated with a filtered Tracking List [symbol] populated with filtered x and y center of gravity coordinates of the object, determined from the M immediately preceding samples. Similarly, the Prediction List PL is populated with N predicted future trajectory points of the corresponding object.

The trajectory prediction module 308 is configured to perform trajectory filtering to filter out measurement noise in the trajectory points determined by the object tracking module 307. The trajectory prediction module 308 is configured to generate a filtered trajectory point P_{fk}, corresponding with {x_{c}, y_{c}}ᵢ^{t}^{ₖ}of an i^{th} detected object, based on an observed trajectory point Pₖ=[(x_{c}, y_{c})ᵢ^{t}^{ₖ}]^{T} and three preceding observed trajectory points Pₖ₋ⱼ=[(x_{c}, y_{c})ᵢ^{t}^{_{k−j}}]^{T}, j=3,2,1 from the corresponding Tracking List TL, such that,

P_{fk}=∝*Pₖ+(1−∝)Pₚₖ (4)

where:
∝=a smoothing parameter which models a confidence value in the observed trajectory points; and
Pₚₖ=a predicted position of the observed trajectory point Pₖ.

In an embodiment of the present disclosure, the predicted position Pₚₖ of the observed trajectory point Pₖ is calculated using a predicted velocity vₚₖ₋₁ of associated non-stationary object and the predicted position of the trajectory point in the immediately preceding sample, such that,

Pₚₖ=P_{fk-1}+Vₚₖ₋₁. (5)

The predicted velocity at sample k is predicted as:

vₚₖ₋₁=∝*vₖ₋₁+(1−∝)*v_{k 2} (6)

### Where:

vₖ₋₁ and vₖ₋₂ are the observed velocities of the object at samples k−1 and k−2 respectively.

An observed velocity of the object at a sample k−1 is determined from the filtered trajectory points at these samples as follows:

vₖ₋ᵢ=P_{fk-i-1}, i=1,2 (7)

Combining equations (4) to (7), a linear filter equation may be obtained of a form, such that:

P_{fk}=w₀*P_{fk-3}w₁*P_{fk-2}+w₂*P_{fk-1}+w₃*Pₖ (8)

where

w₀=−(1−∝)*(1−∝) (9a)

w₁=(1−∝)*(1−2*∝) (9b)

w₂=(1+∝)(1−∝) ..(9c)

w₃=∝ (9d)

It is to be noted that, three of the four position vectors in equations (9a-9b) are previous outputs of the filter, namely P_{fk-3}, P_{fk-2} and P_{fk-1}. Thus, the filter is recursive, which makes its unit impulse response longer and filtering highly effective from a computational point of view. The filter weights add up to one, regardless of the parameter ∝. This property is found in all interpolation filters. Thus, the proposed filter can be also viewed as an interpolator filter.

The trajectory prediction module 308 use the first three observed points of the trajectory in equation (7) at the start of the filtering process, and then replaces the filtered trajectory points (i.e. the output of the filtering process) (P_{fi} for i=0,1,2) generated from the first 3 samples, with the observed trajectory points generated in those samples (Pᵢ, for i=0,1,2). It may be noted that for every newly generated stored object record the trajectory prediction module 308 filters all the trajectory points in the stored object record's Tracking List TL using equations (4) to (9). However, for a pre-existing stored object record, only the last trajectory point in the stored object record's Tracking List TL is new, so only that last trajectory point is filtered.

In the context of the present disclosure, it is assumed that velocity is measured in terms of changes in the non-stationary object's position coordinates from one sample to the next. Similarly, acceleration is expressed as velocity change from one sample to the next. Further, the trajectory prediction is short-term. Therefore, it is assumed that changes in trajectory direction and the magnitude of the acceleration of a non-stationary object remain constant over a next few predicted video frames/images, unless the predicted trajectory collides with a static (non-moving) object in the aerial movement volume 110. This implies that the magnitude of the non-stationary object's acceleration is also preserved. However, as long as the longitudinal and the normal components of the object's acceleration vector remain correspondingly aligned with the object's direction of movement, the orientation of the object's acceleration vector changes with the orientation of the object's velocity vector.

The state vector Sₖ of the non-stationary object (using the filtered trajectory from the trajectory filtering step) at a filtered trajectory point P_{fk} in sample k is given by

Sₖ=[xₖ, yₖ, vₓₖ,v_{yk}, aₓₖ, a_{yk}], (10)

where
vₓₖ, v_{yk}=the horizontal and vertical components of the observed velocity vector of the non-stationary object (determined by equation (7));
vₓₖ₋₁, v_{yk-1}=horizontal and vertical components of the observed velocity vector of the non-stationary object at sample k−1; and
aₓₖ, a_{yk}=corresponding horizontal and vertical components of the object's acceleration vector at sample k and computed using the following equation:

aₓₖ=vₓₖ−vₓₖ₋₁ (11a)

a_{yk}=v_{yk}−v_{yk-1} (11b)

Further, the magnitude |v|ₖ and direction φₖ of the velocity vector vₖ of state Sₖ are calculated based on the following equations:

|v|ₖ=\sqrt{vₓₖ²+v_{yk}²}, (12a)

φₖ=arg[vₓₖ, v_{yk}], (12b)

The magnitude |a|ₖ and direction θₖ of acceleration vector aₖ of non-stationary object may be represented by the following equations:

|a|ₖ\sqrt{aₓₖ²+a_{yk}²} (13a)

θₖ=arg[aₓₖ, a_{yk}] (13b)

Further, the longitudinal aₗₖ and the normal aₙₖ components of the acceleration vector aₖ relative to the velocity vector vₖ direction are:

aₗₖ=|a|ₖ*cos(φₖ−θₖ) (14a)

aₙₖ=|a|ₖ*sin(φₖ−θₖ) (14b)

Furthermore, the predicted state Sₖ₊₁=[xₖ₊₁, yₖ₊₁, vₓₖ₊₁, v_{yk+1)}, aₓₖ₊₁, a_{yk+1}], for the next sample, is computed as follows:

xₖ₊₁=xₖ+vₓₖ (15a)

yₖ₊₁=yₖ+v_{yk} (15b)

vₓₖ₊₁=vₓₖ+aₓₖ (16a)

v_{yk+1}=v_{yk}+a_{yk} (16b)

φₖ₊₁=arg[vₓₖ₊₁, v_{yk+1]} (17)

aₗₖ₊₁=aₗₖ, (18a)

aₙₖ₊₁=aₙₖ (18b)

aₓₖ₊₁=aₗₖ*cos(φₖ₊₁) (18c)

a_{yk+1}=aₗₖ*sin(φₖ₊₁) (18d)

In the context of the present disclosure, the acceleration update equations (18a to 18b) preserve the magnitude of the object's acceleration vector. Also, the acceleration update equations (18a to 18b) re-orients the phase of the object's acceleration vector so that the longitudinal acceleration component corresponds to the current direction of the object's velocity vector; and the normal acceleration component is perpendicular to the current direction of the object's velocity vector. The equations (15 to 18) are propagated as many times, N, as needed. As a result of which, the predicted trajectory is circular. Alternatively, the predicted trajectory may be linear in the absence of a normal acceleration component. Moreover, the angular speed of the non-stationary object is generally variable, and is constant only in the absence of longitudinal acceleration component.

Using the above approach, the trajectory prediction module 308 is configured to generate an updated Object List ObjList(t_{q}) in which the Prediction List PL of each stored object record Objᵢ^{t}^{_{q}} is populated with the predicted trajectories of all the non-stationary objects in the vicinity of the ARD 304, so that each stored object record Objᵢ^{t}^{_{q}} attains the form shown in equation (3).

The collision avoidance module 309 is configured to predict a collision using information generated by the object tracking module 307 and the trajectory prediction module 308; and to control a trajectory of the ARD 304 to avoid nearby moving obstacles. The ARD 304 follows an optimal navigation path 200 as described in FIG. 2 to avoid stationary obstacles, until a collision with a nearby non-stationary object is forecasted based on the routes of those objects predicted by the trajectory prediction module 308. The collision avoidance module 309 is configured to modify navigation path of the ARD 304 by removing trajectory elements of the navigation path in which the ARD 304 is likely to collide with a non stationary object.

In an embodiment of the present disclosure, the prediction based navigation control system 305 may be implemented as one or more microprocessors, microcomputers, microcontrollers, digital signal processors, logic circuitries, and/or any devices that manipulate data based on operational instructions. The prediction based navigation control system 305 may be implemented as a combination of hardware and programming (for example, programmable instructions) to implement one or more functionalities thereof.

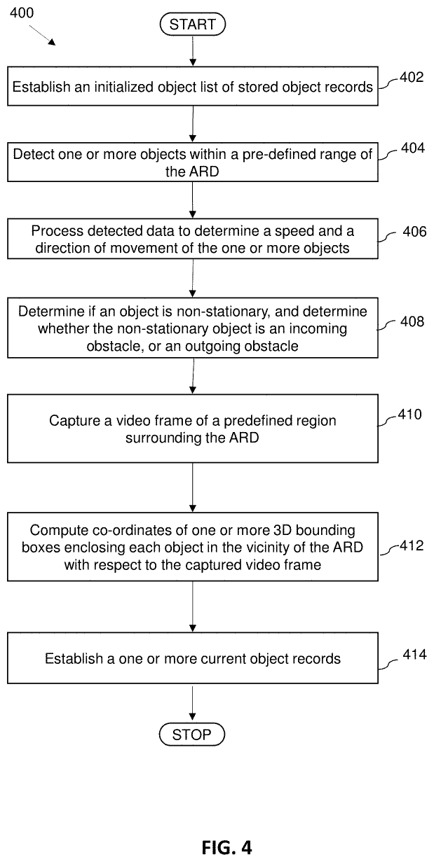

FIG. 4 is a flowchart illustrating a method 400 for detecting non-stationary objects in the aerial movement volume, in accordance with an embodiment of the present disclosure.

At step 402 an object list is established and initialised. The object list comprises a set of stored object records. Each stored object record comprises an object identification number together with the external parameters of a bounding box enclosing a detected object, and the center of gravity coordinates of the said bounding box. In one embodiment, the stored object records in the object list are each initialised with values of 0 or Null as appropriate.

At step 404, one or more objects are detected within a pre-defined distance of the ARD by a radar sensor mounted on the ARD. In the context of the present disclosure, the pre-defined distance is determined by the performance of the radar sensor, and most notably, by the detection range of the radar sensor.

At step 406, data from the radar sensor is processed to determine a speed and a direction of movement of the one or more objects. The radar sensor itself moves in the aerial movement volume, as the radar sensor is mounted on the ARD. However, the radar sensor maintains a constant orientation relative to the direction of movement of the ARD.

At step 408, it is determined if an object is non-stationary and it is then determined whether the non-stationary object is an incoming obstacle, or an outgoing obstacle based on a the direction of movement of the corresponding object described with reference to the orientation of the radar sensor 310 .

At step 410, upon detection of an incoming obstacle, a camera module is triggered to capture an image or video frame of the surrounding area of the ARD, and to compute, at step 412, the external parameters of each 3D bounding box enclosing each object detected in the vicinity of the ARD and the center of gravity coordinates of the said bounding boxes.

At step 414, a set of current object records is established at time instant ‘t_{q}’, wherein each current object record includes the external parameters of a bounding box enclosing a corresponding object detected in the vicinity of the ARD at time instant t_{q}, and the center of gravity coordinates of the said bounding box.

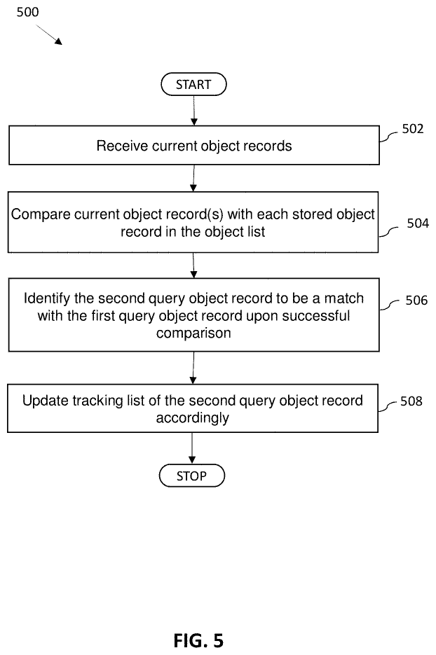

FIG. 5 is a flowchart illustrating a method 500 for tracking non-stationary objects detected in the aerial movement volume, in accordance with an embodiment of the present disclosure.

At step 502, an object list comprising one or more stored object records, and one or more current object records of objects detected in the vicinity of the ARD are received at the sampling rate.

At step 504, each current object record is compared with each stored object record in the object list. The comparing includes determining whether a distance between the x and y center of gravity coordinates of a stored object record and the x and y center of gravity coordinates of a current object record is less than a pre-defined threshold value. For brevity, a stored object record used in the comparing will be referred to henceforth as a first query object record. Similarly, a current object record used in the comparing will be referred to henceforth as a second query object record.

At step 506, the second query object record is identified to be a match with the first query object record, and at least some of the details of the first query object record are updated with corresponding details of the second query object record, when the calculated distance is less than the pre-defined threshold. In an embodiment of the present disclosure, the updating includes replacing the values of the external parameters of the bounding box of the first query object record, with the values of the external parameters of the bounding box of the second query object record, and replacing the values of the center of gravity coordinates of the first query object record with the values of the center of gravity coordinates of the second query object record. The updating further includes adding the values of the x and y center of gravity coordinates of the second query object record to a top of the tracking list of the first query object record, such that the tracking list includes a sequentially ordered list of the locations of the center of gravity of an object detected from samples generated at, a predefined number M or less, of preceding time instants.

At step 508, the tracking list of each stored object record is updated accordingly. In an embodiment of the present disclosure, the tracking list of each stored object record is updated with a predefined M number of previous trajectory points of each corresponding object.

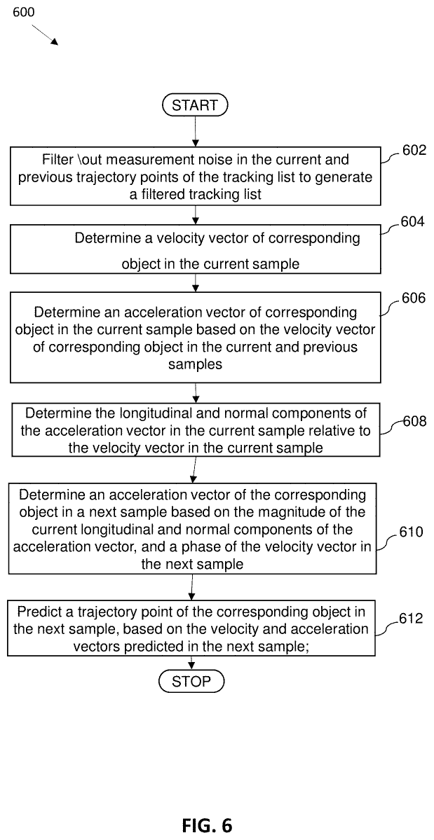

FIG. 6 is a flowchart illustrating a method 600 for predicting trajectory points of one or non-stationary objects tracked in the aerial movement volume, in accordance with an embodiment of the present disclosure.

At step 602, the measurement noise is filtered out in current and previous trajectory points of the tracking list to generate a filtered tracking list of one or more filtered trajectory points. In an embodiment of the present disclosure, a filtered trajectory point is generated based on a trajectory point and three preceding trajectory points from the corresponding tracking list, and a smoothing parameter.

At step 604, a velocity vector of corresponding object in a current sample is determined based on the filtered trajectory points. In an embodiment of the present disclosure, a position of the trajectory point is predicted based on a predicted velocity vector of the corresponding object, and a filtered trajectory point in a previous sample. In another embodiment of the present disclosure, the predicted velocity vector of the object in the current sample is calculated based on velocity vectors of the object in two previous samples. The velocity vector of the object is calculated based on a difference between filtered trajectory points in two previous samples.

At step 606, an acceleration vector of corresponding object in the current sample is determined based on the velocity vector of corresponding object in the current and previous samples. At step 608, the longitudinal and normal components of the acceleration vector are determined in the current sample relative to the velocity vector in the current sample. At step 610, an acceleration vector of the corresponding object is determined in a next sample based on the magnitude of the current longitudinal and normal components of the acceleration vector, and a phase of the velocity vector in the next sample.

At step 612, a trajectory point of the corresponding object in the next sample is predicted based on the velocity and acceleration vectors predicted in the next sample. In an embodiment of the present disclosure, a predicted state vector of the object is generated that includes a next horizontal coordinate computed by adding the current horizontal velocity vector to the current horizontal coordinate, a next vertical coordinate computed by adding the current vertical velocity vector to the current vertical coordinate, a next horizontal acceleration vector computed based on the longitudinal component of the current acceleration vector and a direction of next velocity vector, and a next normal acceleration vector computed based on the normal component of the current acceleration vector, and a direction of next velocity vector.

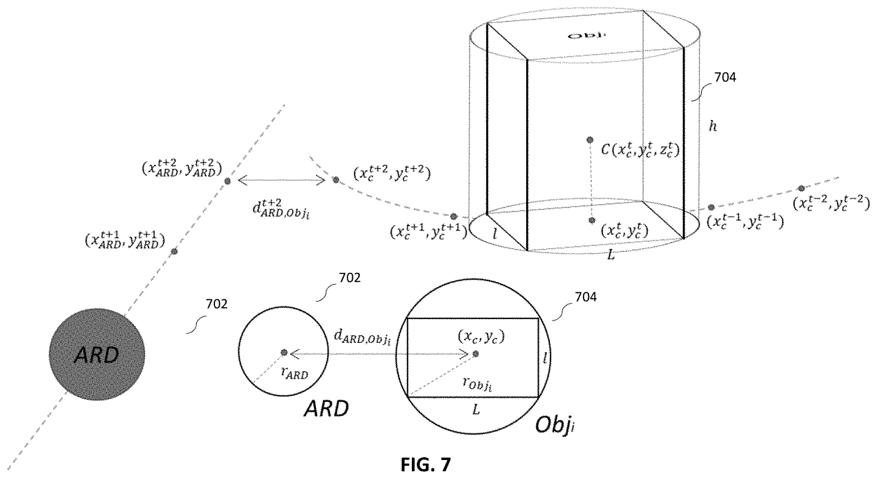

FIG. 7 illustrates the ARD 702 and a non-stationary object 704 moving towards the ARD 702, in accordance with an embodiment of the present disclosure.

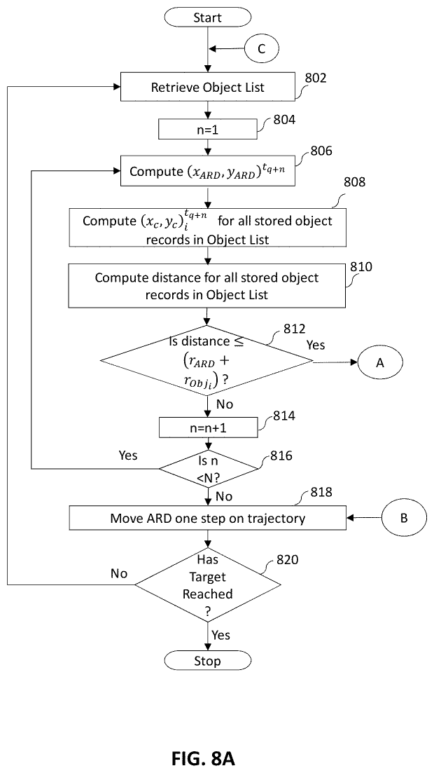

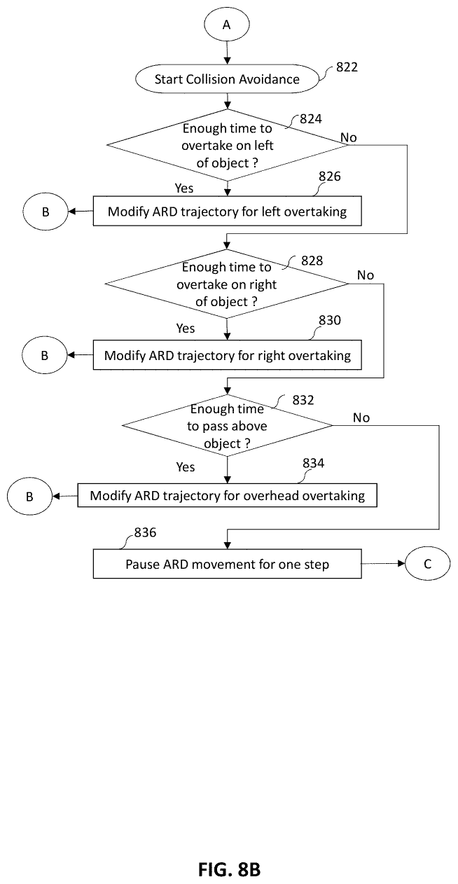

Now referring to FIGS. 7, 8A and 8B, together, at step 802, the updated object list ObjList(t_{q}) (as mentioned in equation 3) is retrieved from the trajectory prediction module. At step 804, a variable n, representing a number of prediction steps ahead, is initialized to be 1. A prediction step ahead corresponds to a time window of duration Δt added to a current sample time t_{q}. Thus, a one step ahead predicted value of a variable is the predicted value of the variable at time t_{q}+Δt. Similarly, a two step ahead predicted value of a variable is the predicted value of the variable at time t_{q}+2Δt and, more generally, an n^{th} step step ahead predicted value of a variable is the predicted value of the variable at time t_{q}+nΔt.

At step 806 an n^{th} (where n=1) step ahead predicted value is computed of the center of gravity (x_{ARD}, Y_{ARD})^{t}^{_{q+n}} of the ARD 702. Further, at step 808, a n^{th} step ahead predicted value is computed of the center of gravity coordinates

$${( {x}_{c} , {y}_{c} )}_{i = 1 to NR ( {t}_{q} )}^{{t}_{q + n}}$$

of each stored object record in the updated object list ObjList(t_{q}), In an example, a n^{th} step ahead predicted value of the center of gravity coordinates (x_{c}, y_{c})ᵢ^{t}^{_{q+n}} of a non-stationary object 704 moving towards the ARD 702 is computed. At step 810, a distance d_{ARD,Ob ji}^{t}^{_{q+n}} is computed between the nth step ahead predicted value of the center of gravity of the ARD 702 and the n^{th} step ahead predicted value predicted value of the center of gravity of each object represented in the updated object list ObjList(t_{q}).

At step 812, a check is performed for each stored object record to ascertain if the distance d_{ARD,Ob ji}^{t}^{_{q+n}} is shorter than the sum of the radius r_{ARD} of the ARD 702 and the half diagonal length r_{obji} of the object corresponding with the stored object record. For brevity, the sum of the radius r_{ARD} of the ARD 702 and the half diagonal length r_{Obji} of an object will be referred to henceforth as an ARD-object clearance distance.

If, for any stored object record, the distance d_{ARD,Ob ji}^{t}^{_{q+n}} is greater than the ARD-object clearance distance, then a collision is not predicted, and at step 814, n is incremented by 1, and at step 816 it is checked whether n is less than or equal to a pre-defined maximum number of prediction steps ahead (N). In the event n≤N then steps 806 to 814 are repeated for next time window (i.e. at time t_{q}+(n+1)Δt). When n is greater than N, the ARD 702 is moved 818 one step ahead on its predefined trajectory. At step 820, it is checked if the ARD 702 has reached its target position. If the target position has not been reached, step 802 is repeated. If, by contrast, the target position has been reached, the method ends.

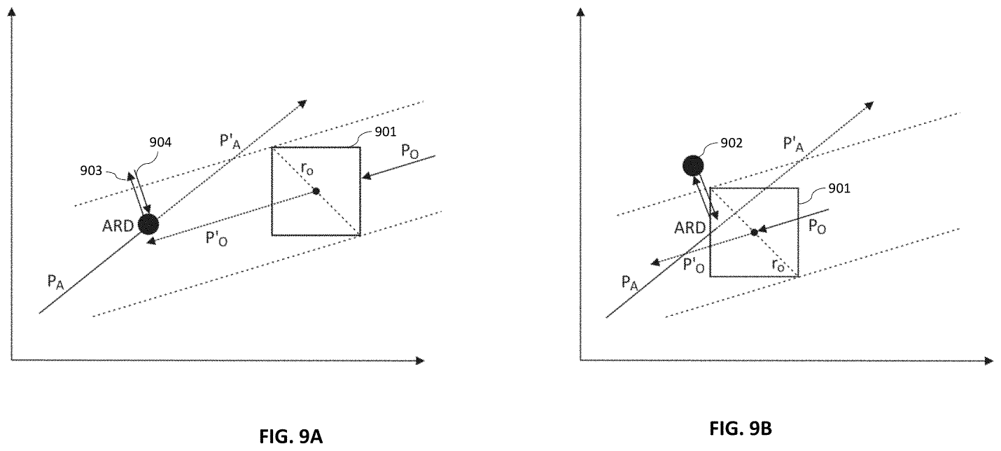

Alternatively, when the distance d_{ARD,Ob ji}^{t}^{_{q+n}} is found to be shorter than the ARD-object clearance distance, then the corresponding object may collide with the ARD 702. Thus, at step 822, collision avoidance is started. At step 824, it is ascertained whether the ARD 702 has enough time to overtake the corresponding object on the left-hand side to avoid collision. In the event the ARD 702 has enough time to overtake the corresponding object on the left-hand side to avoid collision, at step 826, the trajectory of the ARD 702 is modified to enable it to overtake the object on the left-hand side; and step 818 is performed. For brevity, the step of overtaking by the ARD of an object on the left-hand side will be referred to henceforth as left overtaking. The modification of the trajectory of the ARD 702 for left overtaking has been explained with reference to FIGS. 9A and 9B.

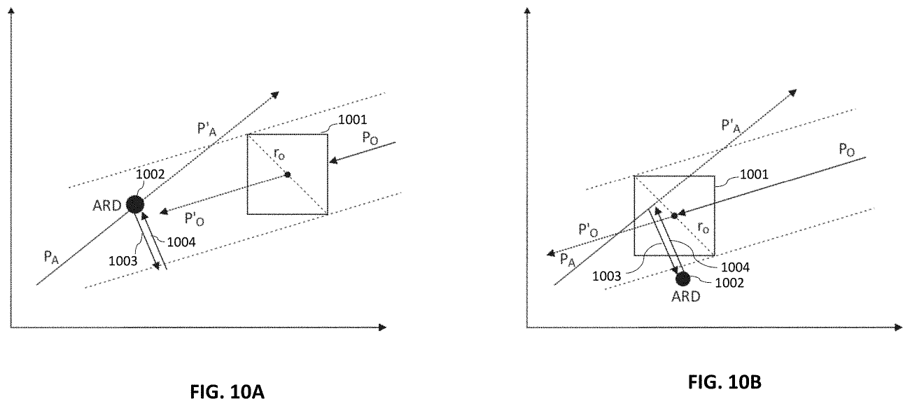

In the event the ARD 702 does not have enough time to overtake the corresponding object on the left-hand side, at step 828, it is ascertained whether the ARD 702 has enough time to overtake the corresponding object on the right-hand side to avoid collision. In the event the ARD 702 has enough time to overtake the corresponding object on the right-hand side to avoid collision, at step 830, the trajectory of the ARD 702 is modified to enable it to overtake the object on the right-hand side, and step 818 is performed. For brevity, the step of overtaking by the ARD of an object on the right-hand side will be referred to henceforth as right overtaking. The modification of the trajectory of the ARD 702 for right overtaking has been explained with reference to FIGS. 10A and 10B.

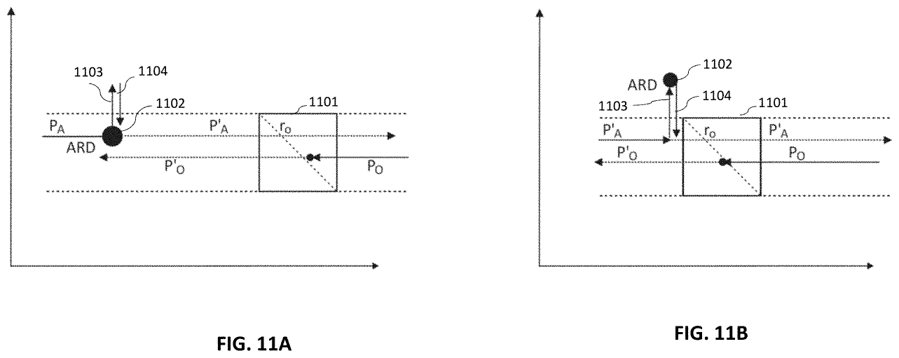

In the event the ARD 702 does not have enough time to overtake the corresponding object on the right-hand side, at step 832, it is ascertained whether the ARD 702 has enough time to overtake the corresponding object by moving overhead it. In the event the ARD 702 has enough time to overtake the corresponding object by moving overhead it, at step 834, the the trajectory of the ARD 702 is modified to enable it to overtake the corresponding object by moving overhead it, and step 818 is performed. For brevity, the step of overtaking an object by moving overhead it will be referred to henceforth as overhead overtaking. The modification of the trajectory of the ARD 702 for overhead overtaking has been explained with reference to FIGS. 11A and 11B.

When the ARD 702 does not have enough time to overtake the corresponding object by moving overhead it, step 836 is performed to pause the movement of the ARD 702 for one step, and step 802 is performed.

In an embodiment of the present disclosure, the collision avoidance module is configured to use angular deviation to activate and supervise the collision detection when a presumptive collision is possible, for example, when the obstacle 704 moves “in front” of the ARD 702 relative to the movement direction of the ARD 702. This safety mechanism is necessary when computation of the absolute coordinates of the obstacles are affected by harsh environmental conditions such as reflexions in the RGBD image, transparent obstacles, etc.

In another embodiment of the present disclosure, the collision avoidance module is configured to modify navigation parameters of the ARD 702 to avoid an impact with the dynamic obstacles. In an example, the speed of the ARD is reduced to zero, until the obstacle 704 passes in front of it. In another example, a current 3D segment of the ARD's 702 navigation path is replaced with a replacement set of 3D segments designed to enable the ARD 702 to avoid all stationary and non-stationary obstacles. To ensure minimal disruption to a previously established navigation path of the ARD 702, the last segment of the replacement set should have the same ending point as the replaced segment of the ARD's 702 navigation path. The process of calculating a suitable replacement set for a 3D segment of the ARD's navigation path, and the replacement of the 3D segment with the calculated replacement set, is applied recursively to the next one or more segments of the ARD's navigation path until the ARD 702 returns to its previously established navigation path. Another embodiment employs an optimization approach which implements an avoidance decision in the horizontal plane of tall obstacles, and avoidance in the vertical plane of wide obstacles.

FIG. 9A illustrates an obstacle 901 which is being overtaken by an ARD 902 on the left-hand side to avoid a collision. At sample time t_{q}, the obstacle 901 has trajectory Pₒ′ which will cause it to collide with the ARD 902. In an embodiment of the present disclosure, first and second horizontal segments 903 and 904 are inserted into a current segment P_{A} of the navigation path of the ARD 902. The first horizontal segment 903 is oriented orthogonally to the current segment P_{A} of the ARD's navigation path and has a length of N×Δt×ξ, where ξ is the speed of the ARD 902. The first horizontal segment 903 starts from the current position of the ARD 902, and is oriented to the left of the current direction (P_{A}′) of movement of the ARD 902. The second horizontal segment 904 is superimposed on the first horizontal segment 903, but is oriented in the opposite direction thereto.

FIG. 9B illustrates the obstacle 901 and the ARD 902 at an overtaking time instant t_{q}+αΔt (where α≤N). The ARD 902 has moved along the first horizontal segment 903 at distance from the optimal trajectory (PA') sufficient to provide space between the ARD 902 and the obstacle 901 as they pass each other, and thereby prevent a collision. After the obstacle 901 has passed the ARD 902, the ARD 902 follows the second horizontal segment 904 to return to the optimal trajectory (P_{A}′).

FIG. 10A illustrates an obstacle 1001 which is being overtaken by an ARD 1002 on the right-hand side to avoid a collision. At sample time t_{q}, the obstacle 1001 has a trajectory Pₒ′ which will cause the obstacle 1001 to collide with the ARD 1002. In an embodiment of the present disclosure, first and second horizontal segments 1003 and 1004 are inserted into the current segment P_{A} of the navigation path of the ARD 1002. The first horizontal segment 1003 is oriented orthogonally to the current segment P′_{A} of the ARD's 1002 navigation path and has a length of N×Δt×ξ, where ξ is the speed of the ARD 1002. The first horizontal segment 1003 starts from the current position of the ARD 1002 and is oriented to the right of the current direction (P_{A}′) of movement of the ARD 1002. The second horizontal segment 1004 is superimposed on the first horizontal segment 1003, but is oriented in the opposite direction thereto.

FIG. 10B illustrates the obstacle 1001 and the ARD 1002 at an overtaking time instant t_{q}+αΔt (where α≤N). The ARD 1002 has moved along the first horizontal segment 1003, at a distance from the optimal trajectory (P_{A}′) sufficient to provide space between the ARD 1002 and the obstacle 1001 as they pass each other to prevent a collision between the ARD 1002 and the obstacle 1001. After the obstacle 1001 has passed the ARD 1002, the ARD 1002 follows the second horizontal segment 1004 to return to the optimal trajectory (P_{A}′).

FIG. 11A illustrates an obstacle 1101 which is being overtaken by an ARD 1102 from overhead to avoid a collision. At sample time t_{q}, the obstacle 1101 has a trajectory Pₒ′ which will cause the obstacle 1101 to collide with the ARD 1102. In an embodiment of the present disclosure, two line segments 1103 and 1104 are inserted into the current segment P_{A} of the navigation path for the ARD 1102. The first horizontal segment 1103 is oriented orthogonally to the current segment P_{A} of the ARD's navigation path and has a length of N×Δt×ξ, where ξ is the speed of the ARD 1102. The first horizontal line segment 1103 starts from the current position of the ARD 1102, and is oriented overhead of the current direction (P_{A}′) of movement of the ARD 1102. The second horizontal segment 1104 is superimposed on the first horizontal segment 1103, but is oriented in the opposite direction thereto, and is used by the ARD 1102 to enable to return to its original optimal trajectory after the ARD 1102 has overtaken the obstacle 1101.

FIG. 11B illustrates the obstacle 1101 and the ARD 1102 at an overtaking time instant t_{q}+αΔt (where α≤N). The ARD 1102 has moved along the first horizontal segment 1103, at distance from the optimal trajectory (P_{A}′) sufficient to provide space between the ARD 1102 and the obstacle 1101 as they pass each other to prevent a collision. After the obstacle 1101 has passed the ARD 1102, the ARD 1102 follows the second horizontal line segment 1104 to return to the optimal trajectory (P_{A}′).

In an embodiment of the present disclosure, each of the first and second segments may be defined as a line segment connecting two consecutive 3D points from a trajectory point list. Each line segment may be converted into four tuples of parameters for corresponding controllers of the four electrical stepper motors of corresponding aerial movement volume. The tuple comprises three control parameters (nrotₖ, dirₖ, θₖ), representing the number of rotation steps, the direction of rotation and the speed of rotation required of the electrical stepper motor. The first three tuples are used to control the horizontal movement of corresponding carrier device and the last tuple is used to control the vertical displacement of corresponding ARD.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for navigating an aerial robotic device (ARD) from a first location to a second location in an aerial movement volume, comprising:
an object detection module configured to detect a non-stationary object in the aerial movement volume, and generate a first object record detailing a location of the non-stationary object;
an object tracking module configured to compare the first object record with one or more second object records of one or more objects previously detected in the aerial movement volume, and add the location of the non-stationary object from the first object record to a first position of a tracking list of a substantially matching second object record, such that the tracking list includes a sequentially ordered list of current and previous trajectory points comprising a current location of corresponding non-stationary object and locations of one or more previous detections of the corresponding non-stationary object;
a trajectory prediction module configured to update a prediction list of the substantially matching second object record with one or more next trajectory points predicted over a pre-defined time period T, wherein N samples of a first object record are acquired at a pre-defined rate At over the pre-defined time period T and wherein, for each current sample, wherein the trajectory prediction module is configured to:
filter out measurement noise in the current and previous trajectory points of the tracking list to generate a filtered tracking list of one or more filtered trajectory points;
determine a velocity vector of corresponding object in the current sample based on the filtered trajectory points;
determine an acceleration vector of corresponding object in the current sample based on the velocity vector of corresponding object in the current and previous samples;
determine longitudinal and normal components of the acceleration vector in the current sample relative to the velocity vector in the current sample;
determine an acceleration vector of the corresponding object in a next sample based on magnitude of current longitudinal and normal components of the acceleration vector, and a phase of the velocity vector in the next sample; and
predict a trajectory point of the corresponding object in the next sample, based on the velocity and acceleration vectors predicted in the next sample; and
a collision avoidance module configured to navigate the ARD from the first location to the second location in presence of a non-stationary object based on the updated prediction list of the non-stationary object.

2. The prediction based navigation control system of claim 1, wherein a filtered trajectory point is generated based on a trajectory point and three preceding trajectory points from the corresponding tracking list, and a smoothing parameter.

3. The prediction based navigation control system of claim 2, wherein the trajectory prediction module is configured to calculate a predicted position of the trajectory point based on a predicted velocity vector of the corresponding object and a filtered trajectory point in a previous sample.

4. The prediction based navigation control system of claim 3, wherein the predicted velocity vector of the object in the current sample is calculated based on velocity vectors of the object in two previous samples.

5. The prediction based navigation control system of claim 4, wherein the velocity vector of the object is calculated based on a difference between filtered trajectory points in two previous samples.

6. The prediction based navigation control system of claim 5, wherein the trajectory prediction module is configured to generate a current state vector of the object of the current sample, that includes current horizontal and vertical co-ordinates of a center of gravity of a bounding box enclosing the corresponding object, current horizontal and vertical components of the corresponding velocity vector, and current horizontal and vertical components of the corresponding acceleration vector, wherein the current horizontal component of the acceleration vector is computed based on a difference between the horizontal velocity vectors of the corresponding object in current and previous samples, and the vertical component of the acceleration vector is computed based on a difference between a vertical velocity vectors of the corresponding object in current and previous samples.

7. The prediction based navigation control system of claim 6, wherein the trajectory prediction module is configured to generate a predicted state vector of the object that includes a next horizontal co-ordinate computed by adding the current horizontal velocity vector to the current horizontal co-ordinate, a next vertical co-ordinate computed by adding the current vertical velocity vector to the current vertical co-ordinate, a next horizontal acceleration vector computed based on the longitudinal component of the current acceleration vector and a direction of next velocity vector, and a next normal acceleration vector computed based on the normal component of the current acceleration vector, and a direction of next velocity vector.

8. A method for navigating an aerial robotic device (ARD) from a first location to a second location in an aerial movement volume, comprising:
detecting, by an object detection module, one or more non-stationary objects in the aerial movement volume and generating a first object record detailing a location of the non-stationary object;
comparing, by an object tracking module, the first object record with one or more second object records of one or more objects previously detected in the aerial movement volume and adding the location of the non-stationary object from the first object record to a first position of a tracking list of a substantially matching second object record, such that the tracking list includes a sequentially ordered list of current and previous trajectory points comprising a current location of corresponding non-stationary object and location of one or more previous detections of corresponding non-stationary object;
updating, by a trajectory prediction module, a prediction list of the substantially matching second object record with one or more next trajectory points predicted over a pre-defined time period T, wherein N samples of a first object record are acquired at a pre-defined rate Δt over the pre-defined time period, and wherein for each current sample, the updating of the prediction list comprises:
filtering out measurement noise in the current and previous trajectory points of the tracking list to generate a filtered tracking list of one or more filtered trajectory points;
determining a velocity vector of corresponding object in the current sample based on the filtered trajectory points;
determining an acceleration vector of corresponding object in the current sample based on the velocity vector of corresponding object in the current and previous samples;
determining longitudinal and normal components of the acceleration vector in the current sample relative to the velocity vector in the current sample;
determining an acceleration vector of the corresponding object in a next sample based on a magnitude of current longitudinal and normal components of the acceleration vector, and a phase of the velocity vector in the next sample; and
predicting a trajectory point of the corresponding object in the next sample, based on the velocity and acceleration vectors predicted in the next sample; and
navigating the ARD from the first location to the second location in a presence of a non-stationary object based on the updated prediction list of the non-stationary object.

9. The method of claim 8 further comprising generating a filtered trajectory point based based on a trajectory point and three preceding trajectory points from the corresponding tracking list, and a smoothing parameter.

10. The method of claim 9 further comprising calculating a predicted position of the trajectory point based on a predicted velocity vector of the corresponding object and a filtered trajectory point in a previous sample.

11. The method of claim 10 further comprising calculating the predicted velocity vector of the object in a current sample based on velocity vectors of the object in two previous samples.

12. The method of claim 11 further comprising calculating the velocity vector of the object based on a difference between filtered trajectory points in two previous samples.

13. The method of claim 12 further comprising generating a current state vector of the object of the current sample, that includes current horizontal and vertical co-ordinates of the center of gravity of bounding box enclosing the corresponding object, current horizontal and vertical components of the corresponding velocity vector, and current horizontal and vertical components of the corresponding acceleration vector, wherein the current horizontal component of the acceleration vector is computed based on a difference between the horizontal velocity vectors of the corresponding object in the current and previous samples, and the vertical component of the acceleration vector is computed based on a difference between vertical velocity vectors of the corresponding object in the current and previous samples.

14. The method of claim 13 further comprising generating a predicted state vector of the object, that includes a next horizontal co-ordinate computed by adding the current horizontal velocity vector to the current horizontal co-ordinate, a next vertical co-ordinate computed by adding the current vertical velocity vector to the current vertical co-ordinate, a next horizontal acceleration vector computed based on the longitudinal component of the current acceleration vector and a direction of next velocity vector, and a next normal acceleration vector computed based on the normal component of the current acceleration vector, and a direction of next velocity vector.

15. A non-transitory computer readable medium configured to store a program causing a computer to navigate an aerial robotic device (ARD) from a first location to a second location in an aerial movement volume, said program configured to:
detect a non-stationary object in the aerial movement volume, and generate a first object record detailing a location of the non-stationary object;
compare the first object record with one or more second object records of one or more objects previously detected in the aerial movement volume, and add the location of the non-stationary object from the first object record to a first position of a tracking list of a substantially matching second object record, such that the tracking list includes a sequentially ordered list of current and previous trajectory points comprising a current location of corresponding non-stationary object and locations of one or more previous detections of the corresponding non-stationary object;
filter out measurement noise in the current and previous trajectory points of the tracking list to generate a filtered tracking list of one or more filtered trajectory points;
determine a velocity vector of corresponding object in the current sample based on filtered trajectory points of corresponding object in the current and previous samples;determine an acceleration vector of corresponding object in the current sample based on the velocity vector of corresponding object in the current and previous samples;
determine longitudinal and normal components of the acceleration vector in the current sample relative to the velocity vector in the current sample;
determine an acceleration vector of the corresponding object in a next sample based on magnitude of current longitudinal and normal components of the acceleration vector, and a phase of the velocity vector in the next sample; and
predict a trajectory point of the corresponding object in the next sample, based on the velocity and acceleration vectors predicted in the next sample; and
navigate the ARD from the first location to the second location in a presence of a non-stationary object based on the updated prediction list of the non-stationary object.

16. The non-transitory computer readable medium of claim 15, wherein said program is further configured to generate a filtered trajectory point based on a trajectory point and three preceding trajectory points from the corresponding tracking list, and a smoothing parameter.

17. The non-transitory computer readable medium of claim 16, wherein said program is further configured to calculate a predicted position of the trajectory point based on a predicted velocity vector of the corresponding object and a filtered trajectory point in a previous sample.

18. The non-transitory computer readable medium of claim 17, wherein the predicted velocity of the object in a current sample is calculated based on velocity vectors of the object in two previous samples.

19. The non-transitory computer readable medium of claim 18, wherein said program is configured to generate a current state vector of the object of the current sample, that includes current horizontal and vertical co-ordinates of a center of gravity of bounding box enclosing the corresponding object, current horizontal and vertical components of the corresponding velocity vector, and current horizontal and vertical components of the corresponding acceleration vector, wherein the current horizontal component of the acceleration vector is computed based on a difference between horizontal velocity vectors of the corresponding object in current and previous samples, and the vertical component of the acceleration vector is computed based on a difference between vertical velocity vectors of the corresponding object in the current and previous samples.

20. The non-transitory computer readable medium of claim 19 further comprising generating a predicted state vector of the object that includes a next horizontal co-ordinate computed by adding the current horizontal velocity vector to the current horizontal co-ordinate, a next vertical co-ordinate computed by adding the current vertical velocity vector to the current vertical co-ordinate, a next horizontal acceleration vector computed based on the longitudinal component of the current acceleration vector and a direction of next velocity vector, and a next normal acceleration vector computed based on the normal component of the current acceleration vector, and a direction of next velocity vector.
